(19) United States
(12) Patent Application Publication
(10) Pub. No.: US 2015/0273975 A1
(43) Pub. Date: Oct. 1, 2015

(54) Reverse flow automotive ventilation system

(71) Applicant: Grey Matter Fusion, Inc., Wanaque, NJ (US)

(72) Inventor: Philos Kim, Wanaque, NJ (US)

(21) Appl. No.: 14/228,185

(22) Filed: Mar. 27, 2014

(51) Int. Cl. B60H 1/00

(52) U.S. Cl. CPC B60H 1/00021; B60H 1/00457

(57) ABSTRACT

A reverse flow automotive cooling system for controlling the temperature in a vehicle includes: a reverse flow fan, which can draw air out of a vehicle cabin, via a reverse air flow function; a reverse flow climate control unit; a climate control sensor; light blocking windows; a solar sensor; a solar cell; and an auxiliary battery; such that the reverse flow climate control unit can measure the temperature in the vehicle, and control the operation of the reverse flow fan to pump heated air out of the vehicle cabin in order to reduce and control the temperature. A reverse flow climate control unit can include a processor, a non-transitory memory, an input/output, a sensor reader, and a climate controller, all connected via a data bus. Also disclosed is a method for reverse flow automotive cooling, including sensing the temperature in a vehicle cabin and operating a reverse air flow.

### CROSS-REFERENCE TO RELATED APPLICATIONS

N/A

### FIELD OF THE INVENTION

The present invention relates generally to the field of ventilation systems in cars, trucks, and other vehicles.

### BACKGROUND OF THE INVENTION

Modern vehicles are equipped with both heating and air conditioning systems, which can control the temperature in a vehicle during use.

However, these systems do not operate when the vehicle is parked and the engine key is in the off position. When a vehicle is parked in an area with intense sun during the summer, there are currently only few options available, including:
a. Accepting that the vehicle interior may become extremely hot during the day. For example on the East Coast of the US on a day in July, in a car with a black interior exposed to the sun from 8 am to 1 pm, the temperature inside the car cabin rose to 180 degrees Fahrenheit. In hotter areas, for example in the Southern US, temperatures can become even more extreme.
b. Leave one or more windows open. Which can be somewhat effective, but may leave an access point for thieves, rain, bird droppings, Squirrels and other animals, etc.
c. Find shade under a tree, which may not always be available, and may not be effective, as the shade moves with the sun.

Returning to a vehicle that has been heated in the sun can be very uncomfortable. Even more importantly, excessive heating of vehicle interiors poses significant safety concerns in cases where pets or children are accidentally or recklessly left behind in a parked vehicle. Every year there are unfortunate cases exhibiting the tragic death of children or animals that were left behind in a vehicle during the summer months.

Though modern vehicles have very powerful air conditioning system, which can cool a vehicle once it is started, there are no available systems, solutions, or methods, which can passively cool a vehicle so that driver and passengers can return to a less excessively hot vehicle. There are shades and solar fans for mounting in the windows, but these require extra room in the cabin and effort/time for the driver to install each time the vehicle is parked.

While this might be merely a convenience and luxury for healthy adults, reducing the heat to less oppressive levels prior to reentering vehicle could be safer for elderly persons in a delicate state of health.

As such, considering the foregoing, it may be appreciated that there continues to be a need for novel and improved devices and methods for ventilating the interior of a vehicle.

### SUMMARY OF THE INVENTION

The foregoing needs are met, to a great extent, by the present invention, wherein in aspects of this invention, enhancements are provided to the existing model of vehicle ventilation.

In an aspect, this present invention can reduce the heat trapped in the interior of a vehicle without any active engagement required from the driver by reversing air flow through the current ventilation system, pulling hot air from the cabin through the firewall opening

In an aspect, a reverse flow automotive cooling system can include:
a. a reverse flow fan, such that the reverse flow fan is a ventilation fan, which can suck air out of the cabin, via a reverse air flow function;
b. a reverse flow climate control unit;
c. one or more climate control sensors;
such that the reverse flow climate control unit can measure the temperature in the vehicle, and control the operation of the reverse flow fan to pump heated air out of the vehicle cabin, so that the temperature in the vehicle cabin can be reduced and controlled.

In a related aspect, the reverse flow fan can also operate with a regular air flow, thereby blowing air into the vehicle cabin. In this scenario, the system could operate with either regular flow or reverse flow at any given time.

In a related aspect, the reverse flow automotive cooling system can communicate with a vehicle control system, in order to crack open the sunroof or the windows in the vehicle cabin automatically, so that the temperature in the vehicle cabin can be lowered further by pulling in relatively cooler outside air, while the reverse flow fan is operating.

In yet a related aspect, the reverse flow automotive cooling system can communicate with the vehicle control system to detect occupants in the vehicle, so that the reverse flow climate control unit can be operated to lower the temperature of the vehicle cabin, to protect the well-being of occupants in the vehicle cabin.

In yet another related aspect, the windows of the vehicle can be smart windows, allowing dynamic adaptation of the window light transmission, whereby the amount of sunlight entering the vehicle cabin can be reduced.

In a further related aspect, the reverse flow automotive cooling system can further comprise a solar sensor, which can be used to adjust the reverse flow fan and the window light transmission as a function of measured solar intensity.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. In addition, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a schematic diagram illustrating a reverse flow automotive cooling system, according to an embodiment of the invention.

FIG. 2 is a schematic diagram illustrating a reverse flow climate control unit, according to an embodiment of the invention.

FIG. 3 is a flow chart illustrating a method or process for reverse flow automotive cooling, according to an embodiment of the invention.

### DETAILED DESCRIPTION

Before describing the invention in detail, it should be observed that the present invention resides primarily in a novel and non-obvious combination of elements and process steps. So as not to obscure the disclosure with details that will readily be apparent to those skilled in the art, certain conventional elements and steps have been presented with lesser detail, while the drawings and specification describe in greater detail other elements and steps pertinent to understanding the invention.

The following embodiments are not intended to define limits as to the structure or method of the invention, but only to provide exemplary constructions. The embodiments are permissive rather than mandatory and illustrative rather than exhaustive.

Vehicles, including automobiles and trucks, commonly have heating and air-conditioning systems installed. Such systems can blow either heated or cooled air in via ductwork that has openings into the cabin, wherein one or more blowers facilitate blowing the air into the cabin. More advanced systems, typically called climate control systems, include a fully automated system with a climate control processor and sensor in the cabin to measure the cabin air temperature, to allow the climate control processor to adjust the cabin air temperature. Whether manual or automated all these systems operate on the basis of injecting air into the cabin via a blower or ventilation fan.

In the following, we shall define such a flow of air injected into the cabin, as a regular flow, also referred to as a regular air flow.

Further, we shall define a flow of air, which draws air from inside the cabin to the outside, as a reverse flow, also referred to as a reverse air flow.

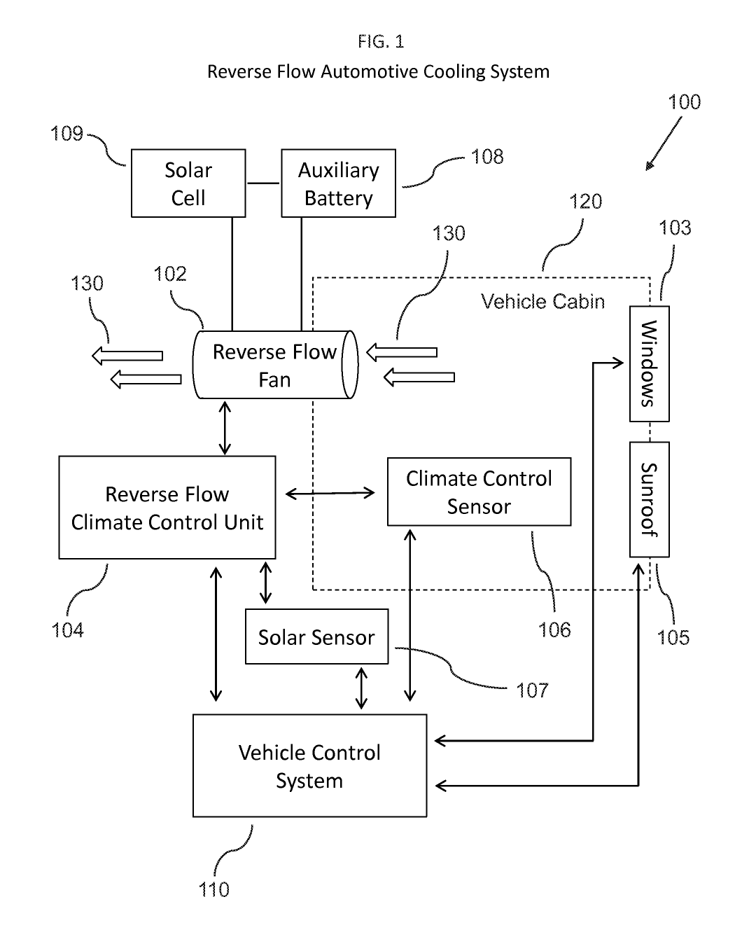

In the following, we describe the structure of an embodiment in the form of a reverse flow automotive′ cooling system with reference to FIG. 1, in such manner that like reference numerals refer to like components throughout; a convention that we shall employ for the remainder of this specification.

In an embodiment, a reverse flow automotive cooling system 100 for controlling the temperature in a vehicle can include:
a. A reverse flow fan 102; wherein the reverse flow fan 102 can be a ventilation fan, which is configured to draw air out from the vehicle cabin 120, via a reverse air flow function;
b. A reverse flow climate control unit 104;
c. At least one climate control sensor 106;
wherein the reverse flow climate control unit 104 can be configured to measure the temperature in the parked vehicle, and control the operation of the reverse flow fan 102 to draw heated air 130 from the vehicle cabin 120; whereby the temperature in the vehicle cabin 120 can be reduced and controlled.

In a related embodiment, sensors 106 can detect elevated temperatures in the cabin of an automobile or other vehicle, due to heating from ambient air temperature outside the vehicle and to a greater extent heating from the sun. Temperatures over a predetermined target value can trigger operation of at least one ventilation fan that is configured to create a reverse flow of air to draw hot air from the cabin, thereby lowering the temperature of the vehicle before the driver/passengers return.

In a related embodiment, the reverse flow fan 102 can be configured to operate with either reverse flow, drawing air from the cabin, or regular flow, injecting air into the cabin.

In a related embodiment, the reverse flow fan 102 can be the normal blower used for air-conditioning and heating in a vehicle, such that the blower in addition to such normal functions is also configured to allow operation in a reverse airflow mode. The reverse flow fan 102 can in this case be bi-directional blower.

In various related embodiments, the reverse flow fan 102 can be a fan, compressor, or other mechanism to create an airflow.

In a related embodiment, for OEM applications, the reverse flow fan(s) 102 can be mounted in the pre-existing heating and cooling ventilation ductwork of a vehicle, with either:
a. A separate fan for reverse fan operation, such that the fan operates when the vehicle regular flow heating and cooling ventilation blower is not operating, and the heating and cooling ventilation system is in the fresh-air mode to allow air flow to pass to the outside; or
b. Support by the same blower fan; allowing either forward or reverse operation.

In a related embodiment, for OEM applications, the reverse flow fan(s) 102 can be mounted in an alternative ventilation duct of a vehicle, separate from pre-existing heating and cooling ventilation ductwork of a vehicle. This can allow the reverse flow fan(s) 102 to operate simultaneously with operation of the heating and cooling system of the vehicle.

In a related embodiment, for aftermarket applications, the reverse flow fan(s) 102 can be mounted on a universal bracket that can be positioned on the firewall opening leading to the pre-existing heating and cooling ventilation ductwork.

In a related embodiment, the reverse flow climate control unit 104 can monitor battery sensors to manage the voltage/amp reserves of the battery and adjust or shutoff the reverse flow fans, in order to not drain the battery beyond what would be necessary to start the vehicle, or in the case of an electric vehicle to leave a reserve to drive the remaining distance intended.

In a related embodiment, the reverse flow climate control unit 104 can communicate with the vehicle control system 110, wherein the vehicle control system can include engine control units and other vehicle control units, including a climate control unit. In some embodiments, the vehicle control system can include control functions to open windows 103 and sunroof 105.

In various related embodiments, the reverse flow automotive cooling system 100 can be powered by the vehicle's normal power system, such that the reverse flow automotive cooling system 100 can be powered from a battery in the vehicle, when the vehicle is parked.

In a further related embodiment, the reverse flow automotive cooling system 100 can further comprise an auxiliary battery 108, which can provide extra reserves to power the reverse flow fan 102. The auxiliary battery 108 can be charged via a connection to the vehicle's normal power system, such that it can be charged during driving of the vehicle.

In a further related embodiment, the reverse flow automotive cooling system 100 can further comprise a solar cell 109, which can be connected to and power the reverse flow fan 102. The solar cell 109 can further be connected to the vehicle battery system, in order to charge the battery system of the vehicle. The connection the vehicle battery system can include a connection to the auxiliary battery 108.

In a related embodiment, the reverse flow climate control unit 104 can further communicate with the vehicle control system 110, in order to open the sunroof 105 automatically to an amount pre-determined by a user, whereby temperature in the vehicle cabin can be lowered more quickly/effectively by ventilating relatively cooler outside air into the cabin, in conjunction with operation of the reverse flow fan 102.

In a related embodiment, the reverse flow climate control unit 104 can further communicate with the vehicle control system 110, in order to open windows 103 automatically to an amount pre-determined by a user, whereby temperature in the vehicle cabin can be lowered more quickly/effectively by ventilating relatively cooler outside air into the cabin, in conjunction with operation of the reverse flow fan 102.

In a further related example embodiment, related to a situation where a vehicle has been parked in the sun, the reverse flow climate control unit 104 can start operation of the reverse flow fan 102 and simultaneously open the windows 103 slightly via communication with the vehicle control system 110. A slight opening can be defined as an opening from 0.5 cm to 3 cm, but may be wider or narrower, such that air flow can be enabled, but easy access to the vehicle cabin 120 is prevented.

In a related embodiment, the reverse flow climate control unit 104 can further communicate with the vehicle control system 110, to detect occupants in vehicle, such that the system can engage when the vehicle is parked and the vehicle control system 110 detects that there are occupants in the vehicle. This can for example protect the well-being of occupants, such as pets or children that have accidentally been left in a parked vehicle. In further related embodiments, this function of the vehicle control system 110 can be configured to operate via a camera or via pressure sensors in the seats.

In a related embodiment, the vehicle windows 103 can be equipped with smart glass technology, which can be controlled to change light transmission properties, changing from transparent to opaque and thereby partially or fully block sunlight entering the vehicle cabin. Such a smart glass function can be provided by a plurality of well-known smart glass technologies, including suspended particle devices, electro-chromic devices, polymer dispersed liquid crystal devices, micro blinds, nano crystals, and other related technologies. Such technologies can combine adaptive light transmission blocking with external reflectivity and low emissivity, and can thereby help control the temperature in a vehicle cabin 120.

In related embodiments, the smart glass function of the windows 103 can be built into the structure of the windows 103, or it can be configured as a film or layer on the internal or external surface of the windows 103.

In a further related embodiment, the reverse flow climate control unit 104 can further communicate with the vehicle control system 110, in order to reduce light transmission on windows 103 of the vehicle cabin, wherein the windows 103 are configured with a smart window function, such that the light transmission can be reduced automatically to an amount pre-determined by a user, whereby temperature in the vehicle cabin can be lowered more quickly/effectively by reducing sunlight entering the vehicle cabin 120, in conjunction with operation of the reverse flow fan 102.

In a further related embodiment, the reverse flow automotive cooling system can further comprise a solar sensor 107, such as a solar radiation sensor, or pyranometer, which can measure solar electromagnetic radiation in wavelength range of 300 to 2,800 nm.

In a yet further related embodiment, the reverse flow climate control unit 104 can be configured to initiate reverse cooling and secondary cooling functions at a predetermined solar intensity level, wherein the secondary cooling functions, include opening the windows 103, opening the sunroof 105, and/or darkening the windows 103. The solar intensity, which can also be referred to as solar irradiance, can typically be measured in watts per square meter.

In a yet further related alternative embodiment, the reverse flow climate control unit 104 can be configured to initiate low power reverse cooling and secondary cooling functions at a predetermined minim solar intensity level and linearly increase the reverse cooling power to a maximum level reached at or above a maximum solar intensity level. The minimum solar intensity can for example be equal to a measured solar intensity of 20 watts per square meter, and the maximum solar intensity level can be 120 watts per square meter.

In a yet further related embodiment, the reverse flow climate control unit 104 can further communicate with the vehicle control system 110, in order to reduce light transmission on windows 103 of the vehicle cabin which are configured with a smart window function, wherein the vehicle control system is configured to reduce window light transmission, such that when the vehicle is a in a parked state and the solar sensor indicates solar intensity exceeds a predetermined power level, the window light transmission can be reduced automatically, whereby temperature in the vehicle cabin can be lowered more quickly/effectively by reducing sunlight entering the vehicle cabin 120, in conjunction with operation of the reverse flow fan 102.

In a yet further related embodiment, the reverse flow climate control unit 104 can further communicate with the vehicle control system 110, in order to reduce light transmission on windows 103 of the vehicle cabin which are configured with a smart window function, wherein the vehicle control system is configured to adjust window light transmission as a function of measured solar intensity, such that when the vehicle is a in a parked state and the solar sensor indicates solar intensity exceeds a minimum solar intensity level, the light transmission can be reduced automatically to a minimum level, and as ambient solar intensity increases to and exceeds a maximum solar intensity level, the light transmission reduction can be increased to a maximum level, whereby temperature in the vehicle cabin can be lowered more quickly/effectively by reducing sunlight entering the vehicle cabin 120, in conjunction with operation of the reverse flow fan 102.

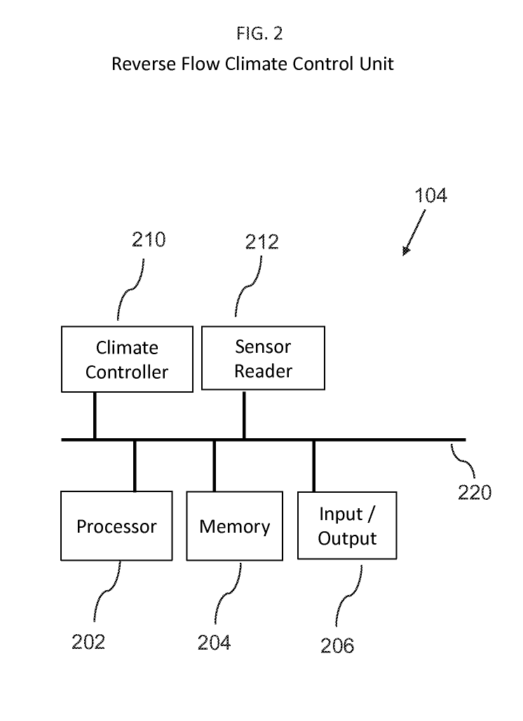

In an embodiment, as illustrated in FIG. 2, the reverse flow climate control unit 104 can comprise the following components:
a. A processor 202;
b. A non-transitory memory 204;
c. An input/output 206;
d. A sensor reader 212;
e. A climate controller 210; all connected via
f. A data bus 220.

In related embodiments, the reverse flow climate control unit 104 can include configurations as:
a. An embedded application, executing on a processing device, such as a vehicle control unit in a vehicle;
b. A component of an existing vehicle climate control system 110, executing on a processing device such as a vehicle control unit in a vehicle;
c. An application executing on a computer device, such as for example a Linux computer device in the dashboard of a vehicle, or a mobile computer device.

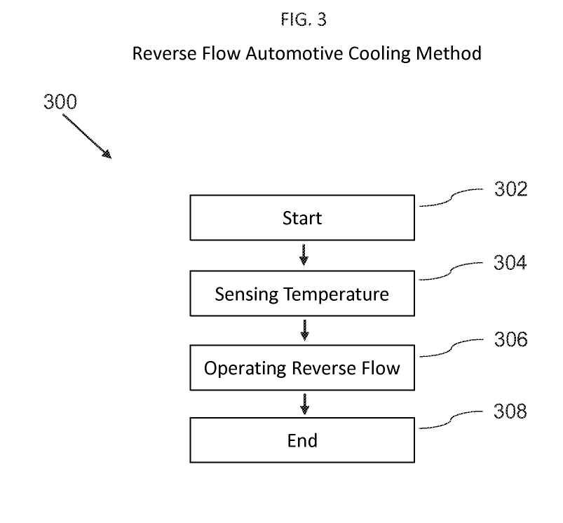

In an embodiment, illustrated in FIG. 3, a reverse flow automotive cooling method 300 for cooling the interior of a vehicle can include:
a. Sensing 304 the temperature in the interior of the vehicle;
b. Operating a reverse flow 306 of air, wherein the rate of reverse flow of air is adjusted to lower cabin temperature from a sensed temperature, whereby hot air is drawn out of the cabin of the vehicle.

FIGS. 1, 2, and 3 are block diagrams and flowcharts methods, devices, systems, apparatuses, and computer program products according to various embodiments of the present invention. It shall be understood that each block or step of the block diagram, flowchart and control flow illustrations, and combinations of blocks in the block diagram, flowchart and control flow illustrations, can be implemented by computer program instructions or other means. Although computer program instructions are discussed, an apparatus or system according to the present invention can include other means, such as hardware or some combination of hardware and software, including one or more processors or controllers, for performing the disclosed functions.

In this regard, FIGS. 1 and 2 depict the computer devices of various embodiments, each containing several of the key components of a general-purpose computer by which an embodiment of the present invention may be implemented. Those of ordinary skill in the art will appreciate that a computer can include many components. However, it is not necessary that all of these generally conventional components be shown in order to disclose an illustrative embodiment for practicing the invention. The general-purpose computer can include a processing unit and a system memory, which may include various forms of non-transitory storage media such as random access memory (RAM) and read-only memory (ROM). The computer also may include nonvolatile storage memory, such as a hard disk drive, where additional data can be stored.

It shall be understood that the above-mentioned components of the reverse flow automotive cooling system 100 and the reverse flow climate control unit 104 are to be interpreted in the most general manner.

For example, the processor 102 can include a single physical microprocessor or microcontroller, a cluster of processors, a datacenter or a cluster of datacenters, a computing cloud service, and the like.

In a further example, the memory 104 can include various forms of non-transitory storage media, including random access memory and other forms of dynamic storage, and hard disks, hard disk clusters, cloud storage services, and other forms of long-term storage. Similarly, the input/output 106 can include a plurality of well-known input/output devices, such as screens, keyboards, pointing devices, motion trackers, communication ports, and so forth.

Furthermore, it shall be understood that the reverse flow automotive cooling system 100 and the reverse flow climate control unit 104 can each respectively include a number of other components that are well known in the art of general computer devices, and therefore shall not be further described herein. This can include system access to common functions and hardware, such as for example via operating system layers such as Windows, Linux, and similar operating system software, but can also include configurations wherein application services are executing directly on server hardware or via a hardware abstraction layer other than a complete operating system.

An embodiment of the present invention can also include one or more input or output components, such as a mouse, keyboard, monitor, and the like. A display can be provided for viewing text and graphical data, as well as a user interface to allow a user to request specific operations. Furthermore, an embodiment of the present invention may be connected to one or more remote computers via a network interface. The connection may be over a local area network (LAN) wide area network (WAN), and can include all of the necessary circuitry for such a connection.

In a related embodiment, the reverse flow climate control unit 104 can communicate with the reverse flow fan 102 over a network, which can be a vehicle communication network, such as CAN, SAE 1939, J1708, J1587 or J1850, but can also include the general Internet, a Wide Area Network or a Local Area Network, or another form of communication network, transmitted on wired or wireless connections. Wireless networks can for example include Ethernet, Wi-Fi, Bluetooth, ZigBee, and NFC. The communication can be transferred via a secure, encrypted communication protocol.

Typically, computer program instructions may be loaded onto the computer or other general-purpose programmable machine to produce a specialized machine, such that the instructions that execute on the computer or other programmable machine create means for implementing the functions specified in the block diagrams, schematic diagrams or flowcharts. Such computer program instructions may also be stored in a computer-readable medium that when loaded into a computer or other programmable machine can direct the machine to function in a particular manner, such that the instructions stored in the computer-readable medium produce an article of manufacture including instruction means that implement the function specified in the block diagrams, schematic diagrams or flowcharts.

In addition, the computer program instructions may be loaded into a computer or other programmable machine to cause a series of operational steps to be performed by the computer or other programmable machine to produce a computer-implemented process, such that the instructions that execute on the computer or other programmable machine provide steps for implementing the functions specified in the block diagram, schematic diagram, flowchart block or step.

Accordingly, blocks or steps of the block diagram, flowchart or control flow illustrations support combinations of means for performing the specified functions, combinations of steps for performing the specified functions and program instruction means for performing the specified functions. It will also be understood that each block or step of the block diagrams, schematic diagrams or flowcharts, as well as combinations of blocks or steps, can be implemented by special purpose hardware-based computer systems, or combinations of special purpose hardware and computer instructions, that perform the specified functions or steps.

As an example, provided for purposes of illustration only, a data input software tool of a search engine application can be a representative means for receiving a query including one or more search terms. Similar software tools of applications, or implementations of embodiments of the present invention, can be means for performing the specified functions. For example, an embodiment of the present invention may include computer software for interfacing a processing element with a user-controlled input device, such as a mouse, keyboard, touch screen display, scanner, or the like. Similarly, an output of an embodiment of the present invention may include, for example, a combination of display software, video card hardware, and display hardware. A processing element may include, for example, a controller or microprocessor, such as a central processing unit (CPU), arithmetic logic unit (ALU), or control unit.

The many features and advantages of the invention are apparent from the detailed specification, and thus, it is intended by the appended claims to cover all such features and advantages of the invention, which fall within the true spirit and scope of the invention.

For example, the reverse flow fan 102 can in an OEM installation be configured to draw air from the cabin via another opening in the shell of the vehicle cabin 120, instead of via the pre-existing heating and cooling ventilation ductwork. This could for example be a water sealed ventilation opening in the roof of the vehicle or in the doors.

In other alternative example embodiments, some or all of the components and functions of the reverse flow climate control unit 104 can be configured as part of the vehicle control system 110, or alternatively some or all of the components and functions of the vehicle control system 110 can be configured as part of the reverse flow climate control unit 104.

Many such alternative configurations are readily apparent, and should be considered fully included in this specification and the claims appended hereto. Accordingly, since numerous modifications and variations will readily occur to those skilled in the art, it is not desired to limit the invention to the exact construction and operation illustrated and described, and thus, all suitable modifications and equivalents may be resorted to, falling within the scope of the invention.

What is claimed is:

1. A reverse flow automotive cooling system for controlling the temperature in a vehicle, comprising of a reverse flow fan, wherein the reverse flow is configured to draw hot air from a vehicle cabin.

2. The reverse flow automotive cooling system of claim 1, further comprising a reverse flow climate control unit;
wherein the reverse flow climate control unit can be configured to control the operation of the reverse flow fan;
whereby the temperature in the vehicle cabin can be reduced.

3. The reverse flow automotive cooling system of claim 2, further comprising at least one climate control sensor;
wherein the climate control sensor is configured to measure a temperature in the vehicle cabin, such that the that reverse flow climate control unit can obtain the temperature in communication with the climate control sensor, and control the operation of the reverse flow fan to pump heated air out of the vehicle cabin, in order to reduce the temperature to a pre-determined target temperature;
whereby the temperature in the vehicle cabin can be reduced and controlled.

4. The reverse flow automotive cooling system of claim 1, wherein the reverse flow fan is further configured to operate with regular flow, whereby the reverse flow can draw air from the vehicle cabin and the regular flow can inject air into the vehicle cabin.

5. The reverse flow automotive cooling system of claim 1, wherein the reverse flow fan is mounted in pre-existing heating and cooling ductwork of the vehicle.

6. The reverse flow automotive cooling system of claim 5, wherein the reverse flow fan is the standard blower used for regular flow operation of heating and air-conditioning, wherein the standard blower is further configured to operate with a reverse flow function.

7. The reverse flow automotive cooling system of claim 1, wherein the reverse flow fan can be mounted with a universal bracket to the firewall opening that connects to pre-existing heating and cooling ductwork of the vehicle, whereby the reverse flow automotive cooling system can be installed as an aftermarket solution.

8. The reverse flow automotive cooling system of claim 1, wherein the reverse flow climate control unit is further configured to communicate with a vehicle control system, in order to optionally open a sunroof in the vehicle cabin automatically, whereby temperature in the vehicle cabin can be lowered more quickly and effectively, in conjunction with operation of the reverse flow fan.

9. The reverse flow automotive cooling system of claim 1, wherein the reverse flow climate control unit is further configured to communicate with a vehicle control system, in order to optionally open at least one window in the vehicle cabin automatically, whereby temperature in the vehicle cabin can be lowered more quickly and effectively, in conjunction with operation of the reverse flow fan.

10. The reverse flow automotive cooling system of claim 1, wherein the reverse flow climate control unit is further configured to communicate with a vehicle control system, in order to reduce light transmission of windows in the vehicle cabin wherein the windows are configured with a smart window function, such that the window light transmission can be reduced automatically, whereby temperature in the vehicle cabin can be lowered more quickly/effectively by reducing sunlight entering the vehicle cabin, in conjunction with operation of the reverse flow fan.

11. The reverse flow automotive cooling system of claim 10, further comprising a solar sensor, wherein the reverse flow climate control unit communicates with the solar sensor, and wherein further when the solar sensor indicates solar intensity exceeds a predetermined level, the window light transmission can be reduced automatically.

12. The reverse flow automotive cooling system of claim 1, further comprising an auxiliary battery, such that the auxiliary battery can be charged via a connection to a normal power system of the vehicle, such that the auxiliary battery can provide extra reserves to power the reverse flow fan.

13. The reverse flow automotive cooling system of claim 1, further comprising a solar cell, such that the solar cell can be connected to and power the reverse flow fan, and further can be connected to a battery system of the vehicle, whereby the solar cell can charge the battery system.

14. The reverse flow automotive cooling system of claim 1, wherein the reverse flow climate control unit is further configured to communicate with a vehicle control system, wherein the vehicle control system is configured to detect occupants in the vehicle, such that the reverse flow climate control unit can engage in order to lower the temperature of the vehicle cabin, whereby the reverse flow automotive cooling system can protect the well-being of occupants in the vehicle cabin.

15. A reverse flow automotive cooling method for cooling the interior of a vehicle can include:
Operating a reverse flow of air to lower cabin temperature from a sensed temperature, whereby hot air can be drawn out of a cabin of the vehicle.

16. The reverse flow automotive cooling method of claim 15, further comprising a first act of:
Sensing the temperature in the interior of the vehicle;
Wherein the act of operating a reverse flow of air, further comprises adjusting the rate of reverse flow in accordance with the sensed temperature.

17. The reverse flow automotive cooling method of claim 15, further comprising operating a regular flow of air, whereby the act of operating a reverse flow of air can draw air from the vehicle cabin and the act of operating a regular flow of air can inject air into the vehicle cabin, in order to control the temperature in the vehicle cabin.

18. The reverse flow automotive cooling method of claim 17, wherein the acts of operating a regular flow of air and operating a reverse flow of air are not done simultaneously.

19. The reverse flow automotive cooling method of claim 17, wherein the act of operating a reverse flow of air is done via an alternative ventilation duct, whereby the acts of operating a regular flow of air and operating a reverse flow of air can be done simultaneously.

20. The reverse flow automotive cooling method of claim 15, further comprising opening a window in the vehicle.

21. The reverse flow automotive cooling method of claim 15, further comprising opening a sunroof in the vehicle.

22. The reverse flow automotive cooling method of claim 15, further comprising adjusting light transmission of windows in the vehicle.

23. The reverse flow automotive cooling method of claim 15, further comprising a preceding act of detecting occupants in the vehicle as a condition of continuing the method.
